(19) United States
(12) Patent Application Publication
(10) Pub. No.: US 2012/0316918 A1
(43) Pub. Date: Dec. 13, 2012

(54) VALUE-GENERATING ALTERNATIVES TO USING VIRTUAL CURRENCY

(75) Inventors: Monty L. Kerr, San Francisco, CA (US); Alexander K. St. John, San Francisco, CA (US); Rajat Kongovi, San Francisco, CA (US)

(73) Assignee: hi5 Networks, Inc., San Francisco, CA (US)

(21) Appl. No.: 13/156,164

(22) Filed: Jun. 8, 2011

(51) Int. Cl. G06Q 30/00; G06Q 10/00; G06Q 50/00

(52) U.S. Cl. 705/7.31; 705/14.73

(57) ABSTRACT

In various embodiments, the present disclosure provides systems, computer-readable media and methods for presenting a user with value-generating alternatives to consuming virtual currency. In some embodiments, it may be determined that a user wishes to consume a content of the service provider, using virtual currency of the user. Usage of the user's virtual currency may generate or potentially generate a first value for the service provider. A value-generating alternative may be selected from a plurality of value-generating alternatives for the user to consume the content, in lieu of using the virtual currency of the user. The selected value-generating alternative may generate or potentially generate a second value for the service provider that is greater than the first value. The selected value-generating alternative may be caused to be presented to the user for the user to consume the content, in lieu of using the virtual currency of the user.

### TECHNICAL FIELD

Embodiments of the present disclosure relate generally to the technical field of data processing, and more specifically to monetizing digital content, including alternatives to using virtual currency to consume digital content provided by a service provider.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Service providers may provide or facilitate digital content (hereafter referred to as “content”) for consumption by users over a computer network. Content of a service provider may be consumed in various ways, and may include all or a portion of a network application provided by the service provider. For example, a user may consume content when the user plays all or a portion of a network computer game, or utilizes some aspect or resource of the network computer game. Other examples of content that may be provided by a service provider include, but are not limited to, music, video, images, textual content (e.g., one or more pages of a virtual book), virtual gifts, activities on a social network and/or dating website (e.g., flirting), visual characteristics of a virtual profile (e.g., a “skin” for a social network profile), and so forth.

A user may be required to meet various requirements prior to consuming content. For example, in a network computer game relating to real estate development, content may take the form of virtual real estate, and one way a user may consume content is to purchase virtual real estate. However, in order to purchase the real estate, the user may be required to use some amount of virtual currency.

Virtual currency can be obtained by a user in various ways. When a user initially purchases the rights to consume content such as a network computer game, the user may be provided with a default amount of virtual currency. The user also may purchase virtual currency. The user also may earn additional currency by achieving various goals or objectives. For example, a user of a real estate network computer game may purchase real estate using virtual currency provided the first time the user played the game. The user may then obtain additional virtual currency by “renting” out the real estate, generating virtual currency in the form of rental income for the user's virtual real estate.

Value may be obtained from users of content provided by a service provider in various ways. For example, a content provider may obtain value directly by charging users real money for content. A content provider also may obtain value indirectly by facilitating consumption of advertising by users, for which the service provider may receive value from the advertiser. Direct and indirect value may be expressed in terms of the effective cost per thousand, or “eCPM”. For example, a percentage likelihood that a user will consume content or participate in an activity may be multiplied by a value generated or potentially generated by the user consuming the content or participating in the activity. The result may then be multiplied by 1,000 to yield the eCPM.

### SUMMARY

In various embodiments, the present disclosure provides systems, computer-readable media and methods for presenting a user with value-generating alternatives to consuming virtual currency. In some embodiments, it may be determined that a user wishes to consume a content of the service provider, using virtual currency of the user. Usage of the user's virtual currency may generate or potentially generate a first value for the service provider. A value-generating alternative may be selected from a plurality of value-generating alternatives for the user to consume the content, in lieu of using the virtual currency of the user. The selected value-generating alternative may generate or potentially generate a second value for the service provider that is greater than the first value. The selected value-generating alternative may be caused to be presented to the user for the user to consume the content, in lieu of using the virtual currency of the user.

### BRIEF DESCRIPTION OF THE DRAWINGS

In the following detailed description, reference is made to the accompanying drawings which form a part hereof wherein like numerals designate like parts throughout, and in which is shown by way of embodiments that illustrate principles of the present disclosure. It is to be understood that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

FIG. 1 schematically illustrates a system according to an embodiment of the disclosure.

FIG. 2 depicts an exemplary method according to an embodiment of the disclosure.

FIG. 3 depicts a timeline showing the likelihood that users will purchase virtual currency, in accordance with an embodiment of the disclosure.

FIGS. 4-7 depict interfaces that facilitate a user choosing between using virtual currency and other alternatives in order to consume a content of a service provider, according to embodiments of the disclosure.

FIG. 8 depicts a post-selection process for collecting and analyzing data, according to an embodiment of the disclosure.

### DETAILED DESCRIPTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

The term “virtual currency” as used herein may be anything digital that is used as a medium of exchange, including any representation of value that may be held by a user, for instance, in a user account associated with online content. It may be represented in various ways, such as “gold coins,” poker chips, virtual goods, jewels, treasure, “bucks,” and so forth.

In providing some clarifying context to language that may be used in connection with various embodiments, the phrases “A/B” and “A and/or B” mean (A), (B), or (A and B); and the phrase “A, B, and/or C” means (A), (B), (C), (A and B), (A and C), (B and C) or (A, B and C).

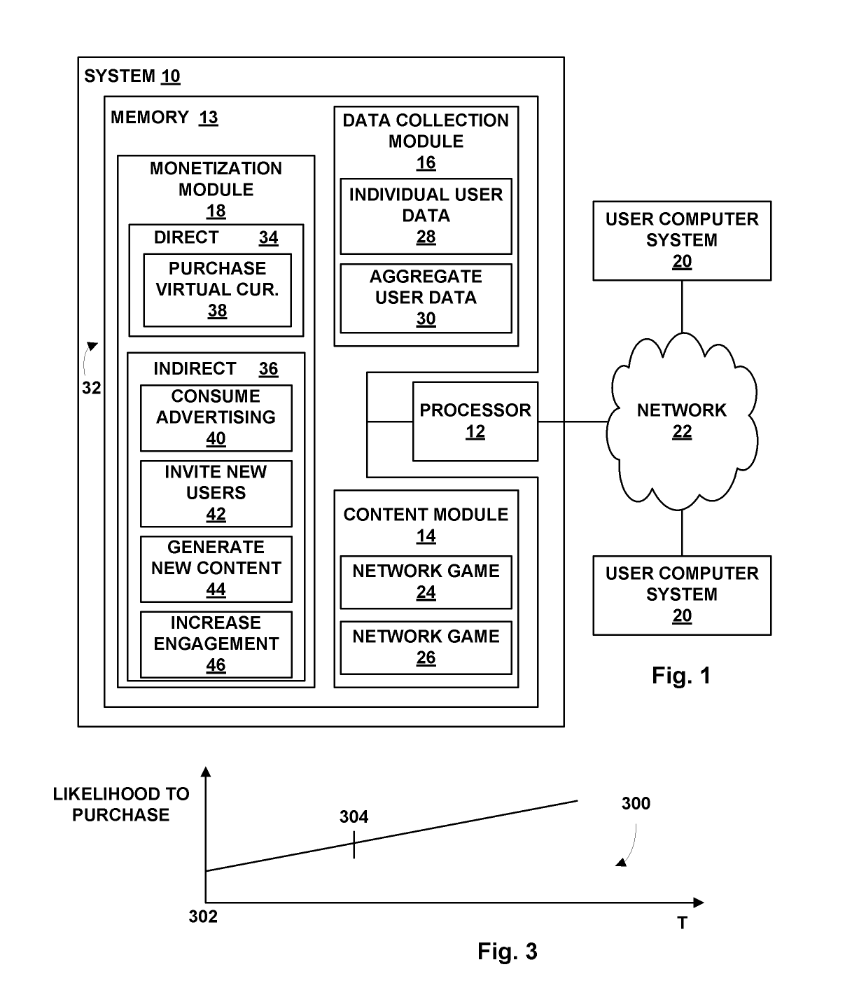

Referring now to FIG. 1, an example computer system 10 includes at least one processor 12 operably coupled to memory 13. While not shown, computer system 10 may include other standard components, such as memory, input and output devices, buses, network interfaces, and so forth.

Computer system 10 may include in memory 13 a content module 14, a data collection module 16 and a monetization module 18, each being operable by processor 12 to perform various functions described below. Although memory 13 is depicted in FIG. 1 as being a single memory, this is not meant to be limiting, and the various modules may be distributed among memories of multiple computers and/or computer systems. For example, each of content module 14, data collection module 16 and monetization module 18 may be included in a separate memory of a separate computer, and those separate computers may be in network communication with each other.

System 10 may be in network communication with one or more user computer systems 20 via a computer network 22. Computer network 22 may be one or more local area networks (“LAN”) and/or one or more wide area networks (“WAN”), including the Internet.

Content module 14 may be operated by processor 12 to provide content offered by a service provider for consumption by one or more users at one or more user computer systems 20 over computer network 22. The content offered by a service provider may or may not be created and/or owned by the service provider. The content offered by a service provider may include any type of content, such as first network game 24 and second network game 26 shown in FIG. 1, as well as content within a network computer game or other application, such as a piece of virtual real estate or a skin for an online profile. In some embodiments, content may be related to and/or facilitated as part of a social network.

Data collection module 16 may be operated by processor 12 to collect data relating to consumption, by users, of content provided by the service provider. Data relating to consumption may include information about any interaction or contact a user has with content, including but not limited to consumption history (e.g., average duration of play, last time played, etc.), purchase history (e.g., information about purchases of virtual currency or other content, amounts paid, frequency of purchasing), creation of content, and so forth. This data may be collected over a period of time, such as from the launch of a network computer game onwards. The data collected may include aggregate user data 30 relating to consumption by a plurality of users. Additionally, the collected data may include individual user data 28 relating to consumption of content by individual users. Further, the collected data may also include data relating to consumption of content by a user's “friends” or “buddies,” for instance, in a social network. As will be discussed below, data collected by data collection module 16 may be used by other components, such as content module 14 and/or monetization module 18, for various purposes.

Monetization module 18 may be operated by processor 12 to select a value-generating alternative from a plurality of value-generating alternatives for the user to consume content of a service provider, in lieu of using virtual currency of the user. This may occur when a user wishes to use virtual currency to consume content provided by content module 14 on behalf of a service provider.

The plurality of value-generating alternatives 32 may include both direct value-generating alternatives 34 and indirect value-generating alternatives 36 for the service provider. Direct value-generating alternatives 34 may include facilitating purchasing additional virtual currency 38 by the user. The value directly generated the service provider is the “real” money provided by the user to the service provider in exchange for more virtual currency.

Indirect value-generating alternatives 36 may include giving the user an option of consuming advertising 40, inviting new users to consume content provided by the service provider 42, generating new user-consumable content for the service provider 44 to provide to users and increasing engagement 46 by the user in content provided by the service provider. Inviting new users may include directly inviting new users by the user, providing information, such as, but not limited to, email addresses, user identifications, of potential new users to the service provider, or making recommendations to other users, such as, but not limited, “buddies” in the user's buddy list, “friends” in the user's social network, or contacts in an email address book.

The value generated or potentially generated from indirect value-generating alternatives may be “indirect” because the value is provided either by a third party (e.g., an advertiser) or because no value is generated immediately, but a potential for additional value is generated. For example, if instead of using virtual currency the user chooses to invite new users to consume content provided by a service provider, the generated value takes the form of potential opportunities to obtain value from the invited users. If the user chooses to generate new content for the service provider, the service provider obtains value in the form of the content itself, for which the service provider may later obtain value. If a user chooses to increase his or her engagement of content of the service provider, then the service provider may have more opportunities to solicit additional value from the user as the user encounters other content that requires virtual currency to consume.

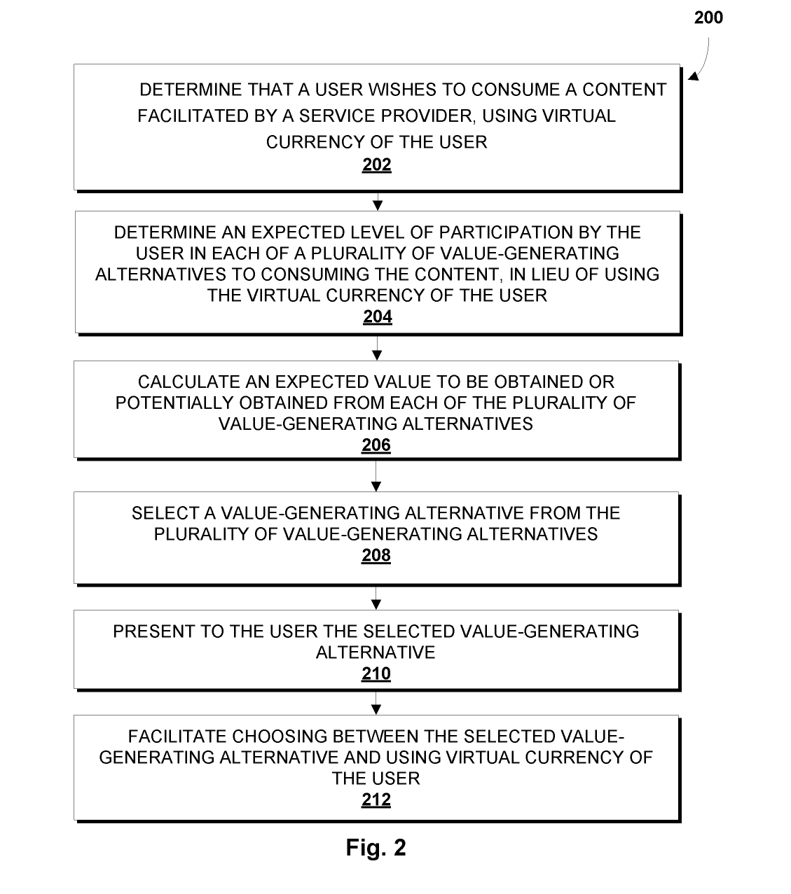

An example method 200 for selecting a value-generating alternative for presentation to a user is depicted in FIG. 2. Although shown in a particular sequence, this is not meant to be limiting and one or more actions may be performed in orders not shown without departing from the spirit of the disclosure.

At 202, content module 14 and/or monetization module 18 may determine that the user wishes to consume a content facilitated by a service provider, using virtual currency of the user. For example, in a real estate network computer game, a user may indicate a desire to purchase virtual real estate using virtual currency of the user.

Usage of the user's virtual currency may generate or potentially generate a first value for the service provider. For example, allowing a user to purchase virtual real estate using virtual currency may increase the user's interest in a real estate network computer game by giving the user more of a “stake” in the game. If the user “owns” more property, they may feel more invested and thus may be more likely to consume additional content provided by the service provider. In other words, allowing a user to use virtual currency to consume content may provide value in the form of future opportunities for a service provider to solicit value from the user.

At 204, an expected level of participation by the user in each of a plurality of value-generating alternatives (e.g., 32 in FIG. 1) may be determined, e.g., by data collection module 16 and/or monetization module 18. In some embodiments, this determination may be made using data collected by data collection module 16, such as individual user data 28 and/or aggregate user data 30.

For example, the likelihood that a user will purchase additional virtual currency, instead of using existing virtual currency, may be determined in one embodiment by comparing play habits and virtual currency purchase history of the user to play habits and purchase history of multiple users (e.g., all users or similar or otherwise related users). The likelihood that a user will invite additional users to consume content provided by a service provider, instead of using the user's virtual currency, may be determined in one embodiment by analyzing sharing habits of other users with similar content consumption habits as the user.

In some embodiments, activities and/or purchase histories of a plurality of users may be analyzed, e.g., by data collection module 16 and/or monetization module 18, to determine points at which users are most likely (or least likely) to participate in each of the plurality of value-generating alternatives. Thereafter, when a user indicates a desire to use virtual currency, the likelihood that the user will participate in a given value-generating alternative at that point may be determined, e.g., by data collection module 16 and/or monetization module 18, based at least in part on the proximity of that point to one of the points at which users are most likely (or least likely) to participate in each of the plurality of value-generating alternatives.

In some embodiments, a monetization score may be assigned to a user and may represent a likelihood that a user will engage in direct commerce and/or other value-generating alternatives. In some embodiments the monetization score may be stored with individual user data 28 in FIG. 1. In some embodiments, a user's choice between using virtual currency and a value-generating alternative may affect the likelihood that the user will be presented with that value-generating alternative in the future.

A higher monetization score might mean that the user is more likely to engage in purchasing additional currency. Such a user may be classified as a “buyer” of virtual currency, as opposed to, for instance, a “non-buyer.” The monetization score may be used by monetization module 18 to determine whether it is more desirable to present a value-generating alternative or the option of the user purchasing additional virtual currency. Additionally or alternatively, the monetization score may be used to determine which value-generating alternative to present to the user.

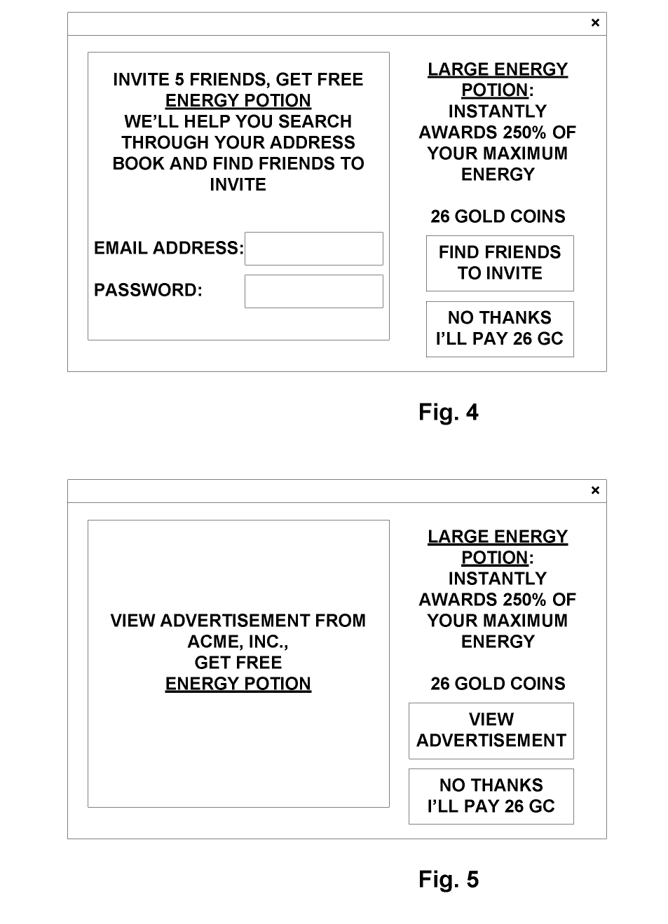

FIG. 3 depicts an example period of time 300, which may be any period of time relating to user consumption of content. Assume for this example that period of time 300 represents overall time spent playing a network computer game, starting at point 302. Aggregate user data (e.g., 30 in FIG. 1) may be analyzed, e.g. by data collection module 16 and/or monetization module 18, to determine a likelihood that a user will purchase additional virtual currency in lieu of using existing virtual currency.

Assume that at point 304 after a user starts playing, it is determined, e.g., by content module 14 and/or monetization module 18, that the user wishes to consume a content. Monetization module 18 may determine that giving the user the option to purchase additional virtual currency may produce an immediate value for a service provider. However, monetization module 18 may also determine that, at point 304, the user may be more likely to purchase virtual currency than at any point previous, but that likelihood is going to increase over time. Thus, monetization module 18 may select another value generating alternative, such as advertising or increasing engagement, to keep the player playing, with the hope that an increase in the user's lifetime value outweighs the immediate value that would be produced by a purchase of additional virtual currency.

In some embodiments, a user with an unusually high monetization score (i.e., someone who purchases a lot of virtual currency in a short amount of time) may be flagged. One example is a minor that runs up a parent's credit card bill playing a network computer game without the parent's knowledge. Such a parent may be likely to refuse to pay the bill and/or claim it as fraud. This may be avoided by presenting value generating alternatives to a minor before they have a chance to run up a large bill (e.g., when the monetization score reaches a particular threshold). A parent might be more likely to pay a lower credit card bill, rather than claiming fraud, and the minor will have been presented with other value-generating alternatives that may generate indirect value from the minor and or other users invited by the minor.

Referring back to FIG. 2, at 206, the expected value to be obtained or potentially generated from each of the plurality of value-generating alternatives may be calculated, for instance, by monetization module 18. These calculations may use various data as input, such as individual user data 28 and/or aggregate user data 30, as well as the expected levels of participation by the user in the plurality of value-generating alternatives determined at 204 (e.g., the monetization score). The expected value to be obtained or potentially obtained from each value-generating alternative may be calculated differently.

An expected value to be generated or potentially generated for the service provider from the user purchasing additional virtual currency (38 in FIG. 1) may be determined in some embodiments as follows. The likelihood that a user will purchase additional virtual currency, e.g., using a monetization score as determined at 204, may be multiplied by a real value (in real currency) that would be obtained from the user in exchange for virtual currency. The result may be multiplied by 1,000 to yield the eCPM. For example, assume there is a 1% chance a user will spend $1 to obtain additional virtual currency rather than using existing virtual currency. Then the eCPM value of the value-generating alternative of selling additional virtual currency to the user is $10 (0.1×$1×1000). This may then compared to the eCPM value of other value generating alternatives to selling virtual currency directly to the user.

An expected value to be generated or potentially generated for the service provider from the user inviting new users to consume content provided by the service provider may be determined in some embodiments as follows. Assume that at 204, a likelihood of the user participating in inviting new users to consume content provided by the service provider was determined as α. A likelihood β of an invited user accepting an invitation to consume content provided by the service provider may be determined. An expected lifetime value σ of a new user also may be determined, for instance, from aggregate user data 30. In some embodiments this expected lifetime value σ may also include the expected lifetime value of any users subsequently invited by a new user. The expected value to be generated or potentially generated for the service provider from the user inviting new users to consume content provided by the service provider therefore may be calculated as the product of α, β, and σ, further multiplied by 1,000 to yield the eCPM value.

For example, a user may be 75% likely to participate in inviting a new user to consume content if presented with that alternative in lieu of consuming virtual currency (α=0.75). There may be a 1% chance that an invited user will accept the invitation and consume content provided by the service provider (β=0.01). An expected lifetime value of a typical user (and in some embodiments, the user's subsequent invitees) may be σ=$1.5. Thus, the expected value to be generated or potentially generated for the service provider from the user inviting new users to consume content is $11.25 eCPM (0.75×0.01×$1.5×1,000).

An expected value to be generated or potentially generated for the service provider from the user consuming advertising may be calculated in some embodiments by multiplying a likelihood of the user consuming the advertising (determined, e.g., at 204) by a value of the user consuming the advertisement. Advertising units may be priced in bundles of 1,000 to facilitate eCPM valuation, and so an additional multiplication by 1,000 may not be needed. For example, assume a user is 90% likely to consume an advertisement in order to consume a content of a service provider, in lieu of using virtual currency. Assume the advertisement has an eCPM of $12. The expected value to be generated or potentially generated by presenting the user with the alternative of consuming advertising would be $10.80 eCPM (0.9×$12).

An expected value to be generated or potentially generated for the service provider from the user creating user-consumable content for the service provider may be calculated in some embodiments as follows. A likelihood of a user creating engaging content, determined at 204, may be multiplied by the value of the content to the service provider. The result may be multiplied 1,000 to obtain the eCPM. Thus, if a user is 50% likely to create engaging content and the value of engaging content is $0.02, then the expected value to be generated or potentially generated by the user creating content is $10 eCPM (0.5×$0.02×1,000).

An expected value to be generated or potentially generated for the service provider from the user increasing engagement in the content may be calculated in some embodiments as follows. A likelihood of a user increasing engagement determined at 204 may be multiplied by an expected increase in lifetime value of the user resulting from the increased engagement. In some cases, an engaged user may cause other users to also become more engaged. In these cases, the value of the net effect of these engagement increases may also be calculated and added to the original user's lifetime value increase. The result may be multiplied by 1,000 to yield the eCPM. Thus, if a user is 10% likely to increase engagement of a particular content, and that increased engagement would add $0.10 to the user's lifetime value, then the expected value to be generated or potentially generated from the user increasing engagement in content is $10 eCPM.

Referring back to FIG. 2, at 208, a value-generating alternative may be selected by monetization module 18 from the plurality of value-generating alternatives (32) for the user to consume the content, in lieu of using the virtual currency of the user. As noted above, the user using existing virtual currency may generate or potentially generate a first value for the service provider. The value-generating alternative selected at 208 may generate or potentially generate a second value that may be greater than the first value.

In some embodiments, the value-generating alternative that will generate the highest immediate value may be selected at 208. In other embodiments, an expected effect on a lifetime value of the user for each of the plurality of value-generating alternatives may be determined, and the alternative having the highest effect on the lifetime value of the user may be selected at 208.

At 210, the selected value-generating alternative for the user to consume the content, in lieu of using the virtual currency of the user, may be presented to the user by monetization module 18. At 212, a computer system of a service provider may facilitate the user in choosing between using virtual currency of the user and participating in the value-generating alternative selected at 208 in lieu of using the virtual currency.

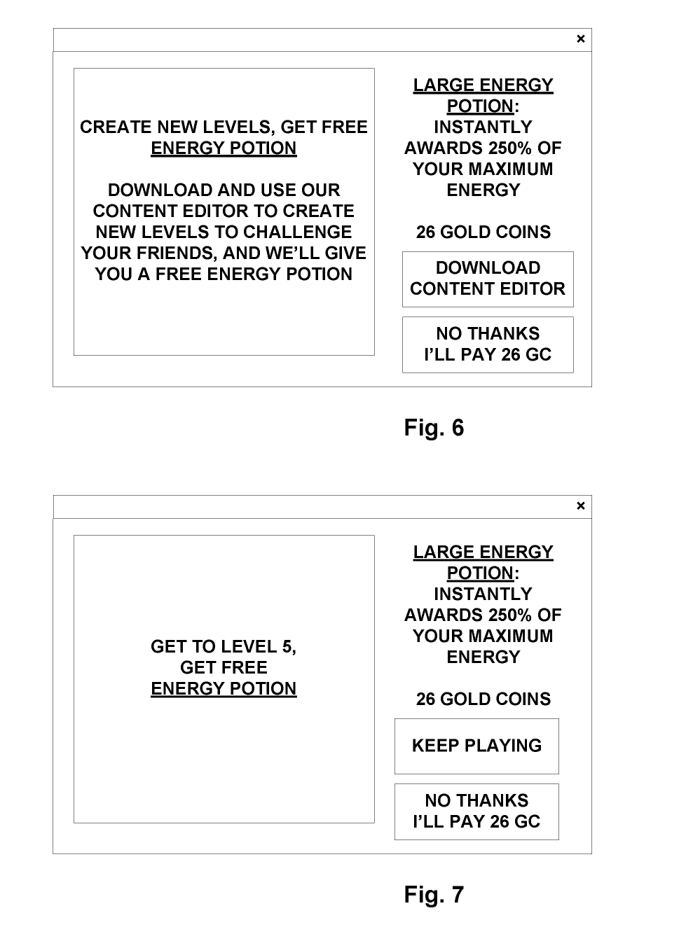

Examples of this are seen in FIGS. 4-8, which depict screenshots of a user interfaces associated with content in the form of a network computer game. In FIG. 4 the user has indicated that she wishes to use virtual currency, or “Gold Coins,” to consume content provided by the service provider in the form of a “large energy potion.” In this interface, the user is presented with the alternative option of inviting new users by entering their email addresses. In some embodiments, the interface may additionally or alternatively facilitate selection of one or more fellow users from a social network of which the user is a member.

In FIG. 5 the user again has indicated that she wishes to use “Gold Coins,” to consume a “large energy potion.” In this interface, the user is presented with the alternative option of viewing advertising in lieu of using “Gold Coins.”

In FIG. 6 the user again has indicated that she wishes to use “Gold Coins,” to consume a “large energy potion.” In this interface, the user is presented with the alternative option of creating content for consumption by users, in lieu of using “Gold Coins.” Here, the option of downloading and using a content editor is presented. However, other simpler ways a user may create content include but are not limited to reviewing another player's progress, personalizing characters or items in a network computer game, ranking friends, and so forth.

In FIG. 7 the user again has indicated that she wishes to use “Gold Coins,” to consume a “large energy potion.” In this interface, the user is presented with the alternative option of increasing engagement in lieu of using “Gold Coins.” Examples of increasing engagement may include the user getting to a specific level (e.g., “Get to Level 5”) or completing a quest or mission (e.g., “Defeat the Evil Dragon”).

After a user chooses between the value-generating alternative and using virtual currency to consume content (as facilitated at 212), various data may be collected and analyzed. For example, data collection module 16 may collect data relating to the user's choice and facilitate use of this data by other components such as monetization module 18. Thus, when the user indicates in the future that she wishes to use virtual currency to consume content of a service provider, the collected data may be used to select (208) appropriate value-generating alternatives.

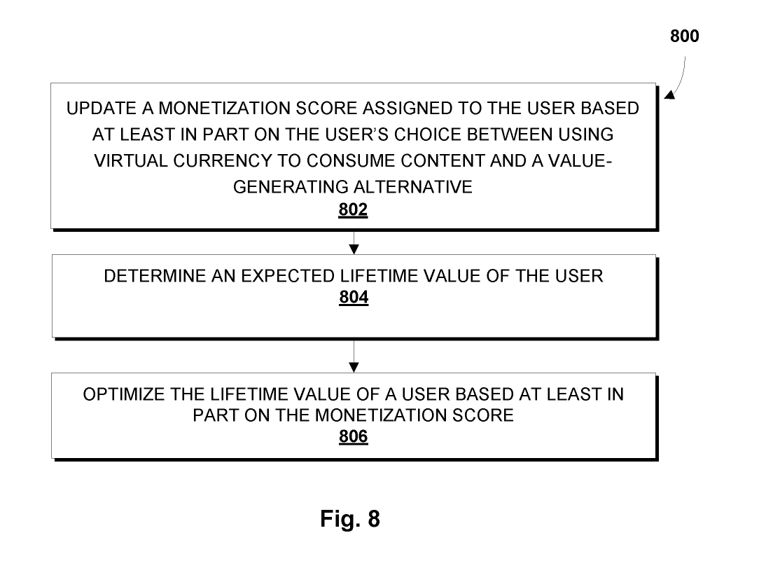

An exemplary post-choice process 800 is depicted in FIG. 8. At 802, the monetization score of the user may be modified, e.g., by monetization module 18 or data collection module 16, based, e.g., on the user's choice at 212.

At 804, an expected lifetime value of the user may be determined, e.g., by monetization module 18, based on various data. For example, a user with a high monetization score may be likely to have a high lifetime value. Even a user with a low monetization score may have a high lifetime value score where that user is particularly likely to invite other users to consume content and those users are likely to accept. For example, users in developing countries may be offered the option of inviting more users, particularly where the invited users are more likely to purchase virtual currency (e.g., users in developed nations).

At 806, the lifetime value of the user may be optimized, e.g., by monetization module 18, based at least in part on the monetization score. A user's current level of engagement with a content (or a plurality of content, such as multiple network games of a particular service provider) may be determined. Using this level of engagement and/or the monetization score determined at 802, particular value-generating alternatives may be selected over others to optimize a user's lifetime value.

For example, it may be determined that a lifetime value of a user who is relatively unengaged in a content (e.g., a user who seldom plays a network computer game) may be optimized (e.g., to obtain the highest possible value) by increasing the user's level of engagement. To increase a user's engagement in content such as a network computer game, when the user indicates that she wishes to use virtual currency, the value-generating alternative that is presented to the user may be to increase his or her engagement. As another example, a user of a network computer game in one country may be rewarded for engaging with users of the network computer game in other countries. In some embodiments, particularly where a user is highly likely to purchase virtual currency, offers to view advertising may be mixed in with offers for a user to purchase additional currency so that the user is not “shocked” by their credit card bill at the end of a paying period. In some embodiments, if a user is approaching the end of a network computer game, thus meaning their lifetime value is almost used up, the user may be presented with the value-generating alternative of starting another different network computer game.

Actions similar to those at 802-806 may be performed on a larger scale to optimize value generated by a plurality of users of content such as a network computer game, or even across multiple network computer games. For example, it may be determined, using information such as individual user data 28 (e.g., monetization scores) and/or aggregate user data 30, that a network computer game's potential to generate value may be increased by adding users. A score similar to the monetization score for a user may be assigned to the network computer game. The score may indicate various things, such as that the network computer game would benefit from more users. In such a scenario, when a user consuming the network computer game is presented with a value-generating alternative to using virtual currency to consume content, it may be more likely that the value-generated alternative selected for presentation is the user inviting additional users to consume the content.

Selection of the value-generating alternative from the plurality of value-generating alternatives at 208 may be based on any number of other data in addition to those discussed above. These data may be user-based; that is, collected (e.g., by data collection module 16) and stored as individual user data 28 and/or aggregate user data 30. These data also may be non-user-based, and may be compared to user data to make decisions as to the best value-generating alternative to present to a user or users at a given moment or in a particular network computer game.

One example of non-user data upon which selection may be based is time of day. Users in the aggregate may be more likely to purchase additional virtual currency at lunch time than after dinner. Thus, if a user indicates a wish to use virtual currency to consume content at lunchtime, the user may be presented (210) with the value-generating alternative of purchasing additional virtual currency (38). If the user indicates a wish to use virtual currency to consume content at nighttime, then the user may be presented with one of the other value-generating alternatives (e.g., 40-46).

Other examples of user and non-user data that may be used to select a value generating alternative include but are not limited to a type of content the user wishes to consume, which network computer game a user is playing, a geographic location of a user, economic conditions of a nation or region of a user, a type of currency used by a user, characteristics of the user such as the user's age, gender, religion, occupation, and so forth.

Although specific embodiments have been illustrated and described herein, it is noted that a wide variety of alternate and/or equivalent implementations may be substituted for the specific embodiment shown and described without departing from the scope of the present disclosure. The present disclosure covers all methods, apparatus, and articles of manufacture fairly falling within the scope of the appended claims either literally or under the doctrine of equivalents. This application is intended to cover any adaptations or variations of the embodiment disclosed herein. Therefore, it is manifested and intended that the present disclosure be limited only by the claims and the equivalents thereof.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A computer-implemented method, comprising:
determining, by a computer system of a service provider, that a user wishes to consume a content of the service provider, using virtual currency of the user, wherein usage of the user's virtual currency generates or potentially generates a first value for the service provider;
selecting, by the computer system, a value-generating alternative from a plurality of value-generating alternatives for the user to consume the content, in lieu of using the virtual currency of the user, wherein the selected value-generating alternative generates or potentially generates a second value for the service provider that is greater than the first value; and
causing to be presented to the user, at another computer system of the user, by the computer system, the selected value-generating alternative for the user to consume the content, in lieu of using the virtual currency of the user.

2. The computer-implemented method of claim 1, wherein the plurality of value-generating alternatives includes at least one direct value-generating alternative and at least one indirect value-generating alternative.

3. The computer-implemented method of claim 2, wherein the at least one direct value-generating alternative is purchasing additional virtual currency.

4. The computer-implemented method of claim 2, wherein the at least one indirect value-generating alternative is selected from consuming advertising, inviting new users to consume content of the service provider, generating consumable content for the service provider, or increasing engagement by the user in content of the service provider.

5. The computer-implemented method of claim 4, further comprising:
determining, by the computer system, a likelihood, α, of the user participating in inviting new users to consume content provided by the service provider;
determining, by the computer system, a likelihood, β, of an invited user accepting an invitation to consume content provided by the service provider;
determining, by the computer system, an expected lifetime value of a new user, σ; and
calculating, by the computer system, an expected value to be generated for the service provider from the user inviting new users to consume content provided by the service provider based at least in part on α, β, and σ.

6. The computer-implemented method of claim 5, wherein the expected lifetime value of a new user, σ; includes expected lifetime values of one or more new users invited by the user.

7. The computer-implemented method of claim 1, further comprising determining, by the computer system, from activities of the user over a period of time, an expected level of participation by the user in each of the plurality of value-generating alternatives;
wherein the value-generating alternative is selected from the plurality of value-generating alternatives based at least in part on the expected levels of participation by the user in the plurality of value-generating alternatives.

8. The computer-implemented method of claim 8, further comprising:
calculating an expected value to be generated for the service provider from each of the plurality of value-generating alternatives, based at least in part on the expected levels of participation by the user in the plurality of value-generating alternatives;
wherein the value-generating alternative having a highest expected value to be generated is selected from the plurality of value-generating alternatives for presentation to the user.

9. The computer-implemented method of claim 8, wherein the expected levels of participation by the user in the plurality of value-generating alternatives are determined at least in part by comparing content consumption of the user to content consumption of a plurality of users.

10. The computer-implemented method of claim 1, wherein the value-generating alternative is selected from the plurality of value-generating alternatives based at least in part on a time of day.

11. The computer-implemented method of claim 1, further comprising determining, by the computer system, for each of the plurality of value-generating alternatives, an expected effect on a lifetime value of the user;
wherein the value-generating alternative is selected from the plurality of value-generating alternatives based on the expected effects on the lifetime value of the user of the plurality of value-generating alternatives.

12. The computer-implemented method of claim 1, further comprising analyzing, by the computer system, activities of a plurality of users to determine points at which the plurality of users are most likely to participate in each of the plurality of value-generating alternatives;
wherein the value-generating alternative is selected from the plurality of value-generating alternatives based at least in part on the user's proximity to one or more of the determined points.

13. The computer-implemented method of claim 1, further comprising:
facilitating, by the computer system, the user choosing between the selected value-generating alternative and using the virtual currency of the user; and
assigning, by the computer system, a monetization score to the user based at least in part on the user's choice.

14. The computer-implemented method of claim 13, further comprising:
determining, by the computer system, an expected lifetime value of the user based at least in part on the monetization score; and
optimizing, by the computer system, a lifetime value of the user based at least in part on the monetization score.

15. A non-transitory computer-readable medium having computer-readable code embodied therein, the computer-readable code comprising instructions configured to enable an apparatus, in response to execution of the instructions, to perform a number of operations, including:
determining that a user wishes to consume a content provided by a service provider, using virtual currency of the user, wherein usage of the user's virtual currency generates or potentially generates value for the service provider;
calculating expected values to be generated or potentially generated for the service provider from a plurality of value-generating alternatives for the user to consume the content, in lieu of using the virtual currency of the user, the plurality of value-generating alternatives including one or more of inviting new users to consume content provided by the service provider, generating consumable content for the service provider, and increasing engagement of the content provided by the service provider;
selecting a value-generating alternative from the plurality of value-generating alternatives with a highest expected value to be generated or potentially generated for the service provider; and
causing to be presented to the user the selected value-generating alternative for the user to consume the content, in lieu of using the virtual currency of the user.

16. The non-transitory computer-readable medium of claim 15, wherein the operations further include determining, by comparing past activities of the user to past activities of a plurality of users, one or more expected levels of participation by the user in one or more of the plurality of value-generating alternatives;
wherein the expected values to be generated or potentially generated for the service provider from the plurality of value-generating alternatives are determined based at least in part on the one or more expected levels of participation by the user in the plurality of value-generating alternatives.

17. The non-transitory computer-readable medium of claim 15, wherein the value-generating alternative is selected from the plurality of value-generating alternatives based at least in part on a time of day.

18. The non-transitory computer-readable medium of claim 15, wherein the operations further include determining, by the computer system, for each of the plurality of value-generating alternatives, an expected effect on a lifetime value of the user;
wherein the value-generating alternative is selected from the plurality of value-generating alternatives based at least in part on the expected effects on the lifetime value of the user of the plurality of value-generating alternatives.

19. The non-transitory computer-readable medium of claim 15, wherein the operations further include analyzing, by the computer system, activities of a plurality of users to determine a point at which the plurality of users are most likely to participate in each of the plurality of value-generating alternatives;
wherein the value-generating alternative is selected from the plurality of value-generating alternatives based at least in part on the analysis.

20. The non-transitory computer-readable medium of claim 15, wherein the operations further include:
facilitating, by the computer system, the user choosing between the selected value-generating alternative and using the virtual currency of the user;
assigning, by the computer system, a monetization score to the user based at least in part on the user's choice.
determining, by the computer system, an expected lifetime value of the user based at least in part on the monetization score; and
optimizing, by the computer system, a lifetime value of the user based at least in part on the monetization score.

21. A system, comprising:
a processor;
a content module operated by the processor to facilitate, by a user at a computer system of the user, consumption of a content provided by a service provider;
a data collection module operated by the processor to collect data relating to past consumption of content of the service provider by a plurality of users, including the user, over a period of time; and
a monetization module operated by the processor to:
determine that the user wishes to consume the content of the service provider, using virtual currency of the user, wherein usage of the user's virtual currency generates or potentially generates a first value for the service provider;
based on the data collected by the data collection module, select a value-generating alternative from a plurality of value-generating alternatives for the user to consume the content, in lieu of using the virtual currency of the user, wherein the selected value-generating alternative generates or potentially generates a second value for the service provider that is greater than the first value; and
facilitate the user choosing between the selected value-generating alternative and using the virtual currency of the user.

22. The system of claim 21, wherein the content of the service provider that the user wishes to consume is content of a social network game.
